(19) United States
(12) Patent Application Publication
(10) Pub. No.: US 2004/0092785 A1
(43) Pub. Date: May 13, 2004

(54) Coal slurry stabilization

(76) Inventor: Peter S. Mills, Stamping Ground, KY (US)

Correspondence Address: NIXON & VANDERHYE, PC, 1100 N GLEBE ROAD, 8TH FLOOR, ARLINGTON, VA, 22201-4714, US

(21) Appl. No.: 10/468,918

(22) PCT Filed: Jan. 22, 2003
(86) PCT No.: PCT/GB03/00213

(51) Int. Cl. A62D 3/00

(52) U.S. Cl. 588/256

(57) ABSTRACT

A process for the treatment of an aqueous coal slurry obtained as tailings from a coal treatment plant and containing fine mineral particles comprises adding to the slurry at least 0.2% of a binder and an amount of dispersant effective to reduce the viscosity and facilitate settling of solids, the % being based on the combined weight of water and mineral solids and allowing the solids to settle. The binder is preferably a cementitious material such as a finely divided blast furnace slag and an activator for the binder such a hydrated lime or Portland cement is preferably also included. The dispersant may be a polyarcylate, polycarboxylate or lignosulphonate.

### FIELD OF THE INVENTION

This invention relates to a process for stabilizing aqueous slurries containing fine coal refuse.

### BACKGROUND OF THE INVENTION

In the beneficiation of coal to remove undesirable waste materials, the coal is usually subjected to a washing process with water. As a result aqueous coal slurries, sometimes referred to as coal tailings, are produced which contain finely divided solid particles.

The safe and economical disposal of fine refuse is a major problem in the coal mining industry. The mineral particles which constitute the fine refuse usually have a size of less than about 28 mesh (600 microns) and commonly less than about 48 mesh (300 microns) and sometimes less than 200 mesh (75 microns). The fine refuse is generally of little value due to its low calorific value and high ash content. Disposal is generally achieved by valley fill impoundment, underground mine injection, surface storage piles or slurry pits. Valley fill impoundments are the most cost effective means of disposal. In this process a dam of coarse coal waste is built at the top of a valley and a slurry of fine waste and water is pumped behind the dam. The fines settle out in the impoundment behind the dam and the supernatant water recycled. Once the valley is filled and surface water drained off, the waste is covered with topsoil and vegetation planted.

### PROBLEM TO BE SOLVED BY THE INVENTION

U.S. Pat. No. 4,015,997 describes the addition of from 2 to 50% by weight of ground granulated blast furnace slag to a slurry of coal waste containing from 20 to 80 weight percent of solids. The addition of the slag is for the purpose of converting the solids in the slurry, which would otherwise be unsuitable for use in landfill, into a sedentary mass which can be used in landfill. The slag is intimately mixed with the coal slurry and the mixture is then deposited in a landfill in the presence of excess water with physical and chemical changes taking place so as to form a sedentary mass from the solids. However experience has shown that the blast furnace slag has an inhibiting effect on the settling of solids in the sludge to the extent that there can be a shortage of clear water to recycle to the coal processing plant.

U.S. Pat. No. 4,208,217 describes the addition of a stabilising additive containing Portland cement to an aqueous slurry of coal fines containing about 30 to 80% of solids and allowing the admixture to harden. Preferably the stabilizing additive additionally comprises finely divide blast furnace slag. It is preferred to add sufficient additive in order that the slurry will harden to an unconfined compressive strength of at least 18 p.s.i. in less than 2 days of standing.

However the addition of these materials causes inhibition of solids settling and this problem is not addressed in U.S. Pat. No. 4,208,217.

The present invention provides a solution to the problem of the inhibition of settling of solids caused by the presence of cementitious binders such as slag and Portland cement. The present invention provides a process in which a dispersant is added to the slurry to reduce the viscosity of the slurry and achieve a more effective settling of solids.

### SUMMARY OF THE INVENTION

According to the present invention a process for the treatment of an aqueous coal slurry containing fine solid mineral particles comprises adding to the slurry at least 0.2% of a binder and an amount of a dispersant effective to reduce the viscosity and facilitate settling of solids, the % being based on the combined weight of water, solid mineral particles and binder and allowing the solids to settle.

### ADVANTAGEOUS EFFECT OF THE INVENTION

The solid particles present in the slurries are able to settle out to a greater extent. This means that a greater quantity of supernatant water is available for recycling. In addition the separated solids contain less water and are less susceptible to fluidification caused by extraneous seismic events such as rock blasting.

### DETAILED DESCRIPTION OF THE INVENTION

Supernatant water means water which is sufficiently low in solids to be recyclable to a coal processing plant.

The mesh sizes referred to are Tyler mesh sizes.

The Slurry.

The present invention may be employed to treat a wide variety of slurries obtained as tailings from coal treatment plants but is particularly applicable to slurries whose particles are finer than those typically encountered in coal tailings and whose particles are normally more difficult to separate.

For example, the coal slurry may have particles whose size is such that at least 50% or 70% are less than 100 mesh (150 microns) or at least 50% or 60% are less than 325 mesh (45 microns).

The coal slurry may be tailings from a coal treatment plant and contain from 20 to 80% by weight of solids based on the combined weight of water and solids and the particle size of the solids in the slurry may be such that at least 50% by weight is less than 100 mesh (150 microns).

The Binder.

The binder is preferably a cementitious material such as a blast furnace slag or Portland cement, preferably in finely divided form.

When the binder is a blast furnace slag or other slowly hydrating binder, then an additional material to activate the binder may be employed. Suitable activating materials are those that are a source of lime such as Portland cement or hydrated lime.

The effect of the lime is to increase the pH and activate the hydration which in the case of a blast furnace slag would otherwise be relatively slow.

Suitable binders are those described in U.S. Pat. Nos. 4,015,997 and 4,208,217.

Finely divided blast furnace slag and especially finely divided granulated blast furnace slag is particularly preferred.

The binder conveniently has a particle size such that at least 50%, preferably at least 75% is less than 200 mesh (75 microns).

More preferably at least 30% most preferably at least 50% or 75% by weight of the slag is less than 325 mesh (45 microns).

The amount of binder will normally be from about 0.2 to 15%, preferably from about 1 to 10% by weight of the combined weight of water and mineral solids.

When an activator such as hydrated lime or Portland cement is employed it will normally be present in an amount from 0.02 to 2% preferably 0.05 to 1% based on the combined weight of water, mineral solids, binder and activator.

The Dispersant.

The function of the dispersant is to reduce the viscosity of the aqueous slurry to which the binder has been added and to thereby facilitate settling of the fine mineral solids.

By dispersant in the present specification we mean an additive which reduces the viscosity of the aqueous slurry to which it is added. Such additives are deflocculants which typically have a relatively large anionic component which is adsorbed on positive sites of the slurry particles thereby reducing the attractive forces between the particles.

Suitable dispersants are described in the text book entitled Chemical admixtures for concrete by M. R. Rixom and N. P. Mailvaganam in chapter 1.

Further suitable dispersants are polyacrylates and polycarboxylates and those described in U.S. Pat. No. 6,312,515.

Particularly suitable dispersants for use in the present invention include lignosulphonates and polycarboxylates.

The dispersant may be added to the slurry before the binder, but it is preferred to add the binder to the slurry followed by the dispersant. The binder is usually in the form of solid particles and it is preferred to add the dispersant after the binder particles have wetted out.

This may be achieved by providing a mixer in the line carrying the slurry to the impoundment, adding the binder to the slurry employing the mixer and after the binder particles have been wetted, adding the dispersant. The point at which the dispersant is added will therefore be downstream of the mixer. The slurry containing binder and dispersant may then be fed continuously to the impoundment.

The minimum amount of dispersant effective to promote settling of solids can be determined by experiment. It will normally be at least 0.008% based on the combined weight of water and mineral solids in the coal slurry.

The dispersant is conveniently added as a dispersion in a carrier liquid or solution in a solvent such as water. References to the amount of dispersant, unless the context requires otherwise, are to the dry dispersant ie on a solvent or carrier liquid free basis.

The upper limit will be determined by the effect on the compressive strength of the settled solids and on grounds of cost. Amounts in excess of 1% will generally be avoided.

The amount of dispersant will therefore normally be from 0.008 to 1.0%, preferably from 0.01 to 0.5% by weight of the combined weight of water and mineral solids.

The Settling.

After the addition of the binder and dispersant the slurry is allowed to stand to allow the solids to settle. The standing is preferably in an impoundment where the settled solids are allowed to remain and progressively build up and from where the supernatant water can be withdrawn and preferably recycled to the coal processing plant

To facilitate settling the temperature is preferably above freezing. In normal operation relatively clear water of recyclable quality is continuously withdrawn from the impoundment and slurry is added continuously. To prevent contamination of the relatively clear water with incoming slurry, the relatively clear water for recycling is usually withdrawn from a point spaced apart from the point where the slurry is admitted, for example from the opposite end of the impoundment.

According to another aspect of the present invention there is provided an aqueous coal slurry, for example tailings from a coal treatment plant, containing from 20 to 80% by weight of mineral solids of particle size is such that at least 50% by weight of the solids is less than 100 mesh (150 microns), a cementitious binder for the mineral solids and a effective amount of a dispersant to reduce the viscosity and facilitate settling of the solids.

The particle size of the solids in the coal slurry may be such that at least 50% is less than 325 mesh (45 microns).

The particle size of the binder may be such that at least 50% by weight of the binder, preferably at least 75% is less than 200 mesh (75 microns).

The invention is illustrated by the following Examples.

### EXAMPLE 1

In the Examples a waste fines slurry from Kanawa Eagle operations in West Virginia was used. It contained 30% solids by weight based on the combined weight of solids and water.

The particle size of the solids was as follows:

11.5% larger than 100 mesh (150 microns),

18% between 100 and 325 mesh (45 microns)

and 70% below 325 mesh (45 microns).

The binder was a mixture of ground granulated blast furnace slag and hydrated lime in a weight ratio of 10:1.

The particle size of the slag was such that 99% by weight was finer than 325 mesh (45 microns).

The binder was mixed with the slurry at an addition rate of 2.2% by weight based on the combined weight of solids and water.

Viscosity was measured with a Brookfield RVT viscometer using spindle # 2.

Effect of Dispersant on Viscosity.

TABLE 1

| Order of addition of dispersant/binder | Slurry viscosity |
|---|---|
| No dispersant, binder only | 584 cps |
| Added before binder | 344 cps |
| Added after binder | 144 cps |

Table 1 shows the effect of adding 0.1% by weight of the dispersant Norlig A on viscosity and the effect of adding it before and after the binder.

Norlig A is a 50% solution of calcium lignosulphonate containing about 16% reducing sugars. It is supplied by Lignotech.

A reduction in viscosity is beneficial in promoting settling and provides a quick test of the efficacy of dispersants.

Effect on Settlement.

To prepare a test cylinder, 1000 g of tailings slurry was placed in a one gallon (U.S) mixing vessel. The binder was added and mixed in using a laboratory stirrer (Greaves mixer). When the binder was fully wetted out the dispersant was added whilst mixing. After a few seconds to disperse the dispersant the viscosity was measured using the Brookfield viscometer described previously.

The sample of tailings for this test was obtained on a different day from that used in the tests reported in Table 1 which explains the different viscosities when no dispersant was added.

After measuring the viscosity, the slurries were poured into 3 inch by 6 inch cylinder molds and left for the solids to settle. The volume of decant water expressed as a percentage of the total volume of the cylinder represents the settlement. The measurement were made after one month of standing to allow the solids to settle.

The decant water was the clear water from which the solids have settled out and accumulated at the top of each cylinder.

TABLE 2

| | | | | Settlement in 3 |
|---|---|---|---|---|
| | | | | inch × 6 |
| | | | | inch cylinders |
| Binder by weight of slurry | Byk 156 | viscosity | | @ 1 month |
| 2% slag, 0.2% hydrated lime | 0% | 1400 | cp | 13% |
| 2% slag, 0.2% hydrated lime | 0.04% | 340 | cp | 23% |
| 2% slag, 0.2% hydrated lime | 0.1% | 200 | cp | 47% |

The viscosity reported was at the start of the one month period.

The data shows that the effect of the dispersant was to greatly reduce the viscosity.

Byk 156 is a dispersant sold by BYK Chemie. It is an ammonium salt of a polyacrylate and is a solution in water containing about 40 to 50% solids.

The settlement is obtained by measuring the amount of clear liquid in the cylinder. The % refers to the % of the cylinder height containing the clear water. The higher the figure the greater is the amount of clear water at the top of the cylinder and the better is the settling of the solids.

The effect of the dispersing agent was to increase the settlement from 13% (no dispersant) to 47% (0.1% dispersant) after one month.

This means the quantity of supernatant water i.e. relatively clear water which could be recycled to the coal processing plant was increased by more than 300%.

### EXAMPLE 2

The settled solids of Example 1 were tested for compressive strength after 2 months.

TABLE 3

| | | Unconfined compressive |
|---|---|---|
| Binder by weight of slurry | Byk 156 | strength |
| 2% slag, 0.2% hydrated lime | 0% | 23 psi |
| 2% slag, 0.2% hydrated lime | 0.04% | 30 psi |
| 2% slag, 0.2% hydrated lime | 0.1% | 10 psi |

The measurement of compressive strength was determined by removing the samples from the molds, trimming the ends level and placing the samples in a compression test machine. The results show that a useful unconfined compressive strength is obtained with the addition of the dispersant.

Byk 156 exerts a retarding influence on the slag hydration which probably explains the reduced strength (10 psi) at the higher dosage rate (0.1%) of Byk 156.

Nevertheless where the impoundment is of sufficient size a slow rate of strength development is acceptable as the head of unstabilized slurry is kept within safe limits.

The intermediate level of the dispersant Byk 156 has increased the strength due to the reduced water/binder levels compared with the control.

1. A process for the treatment of an aqueous coal slurry containing fine solid mineral particles which process comprises
adding to the slurry at least 0.2% of a binder and an amount of a dispersant effective to reduce the viscosity and facilitate settling of solids, the % being based on the combined weight of water, solid mineral particles and binder and allowing the solids to settle.

2. A process as claimed in claim 1 wherein the binder is a cementitious material.

3. A process as claimed in claim 2 wherein the particle size of the binder is such that at least 50% by weight of the binder is less than 200 mesh (75 microns).

4. A process as claimed in any one of the preceding claims wherein the binder is finely divided blast furnace slag.

5. A process as claimed in claim 4 wherein an activator for the binder is present.

6. A process as claimed in claim 5 wherein the activator is a material that acts as a source of lime.

7. A process as claimed in claim 6 wherein the material is hydrated lime or Portland cement.

8. A process as claimed in any one of the preceding claims wherein the aqueous coal slurry is tailings from a coal treatment plant and contains from 20 to 80% by weight of solids based on the combined weight of water and solids and the particle size of the solids in the slurry is such that at least 50% by weight of the solids is less than 100 mesh (150 microns).

9. A process as claimed in claim 8 wherein at least 50% is less than 325 mesh (45 microns).

10. A process as claimed in any one of the preceding claims wherein the dispersant is a polyacrylate, polycarboxylate or lignosulphonate.

11. An aqueous coal slurry containing from 20 to 80% by weight of mineral solids of particle size such that at least 50% by weight of the solids is less than 100 mesh 150 microns), a cementitious binder for the mineral solids and an amount of a dispersant effective to reduce the viscosity and facilitate settling of the solids.

12. An aqueous coal slurry as claimed in claim 11 wherein the particle size of the solids in the coal slurry is such that at least 50% is less than 325 mesh (45 microns).

13. An aqueous coal slurry as claimed in claim 11 or 12 wherein the particle size of the binder is such that at least 50%, preferably at least 75% is less than 200 mesh (75 microns).
